(19) United States
(12) Patent Application Publication
(10) Pub. No.: US 2016/0364422 A1
(43) Pub. Date: Dec. 15, 2016

(54) SYSTEM, METHOD AND DEVICE FOR A VIRTUAL ONLINE COMMUNITY INCLUDING A DATABASE OF STRUCTURED AND LINKED INFORMATION ACCESSIBLE TO ACCREDITED MEMBERS

(71) Applicants: Johannes Jacobus Earnest Kapp, Pretoria (ZA); Sheryldene-Anne Valente, Pretoria (ZA); Petrus Stephanus de Villiers, Pretoria (ZA); Armand Ventura, New York, NY (US)

(72) Inventors: Johannes Jacobus Earnest Kapp, Pretoria (ZA); Sheryldene-Anne Valente, Pretoria (ZA); Petrus Stephanus de Villiers, Pretoria (ZA); Armand Ventura, New York, NY (US)

(21) Appl. No.: 15/007,776

(22) Filed: Jan. 27, 2016

Related U.S. Application Data
(60) Provisional application No. 62/174,941, filed on Jun. 12, 2015.

(51) Int. Cl. G06F 17/30

(52) U.S. Cl. CPC G06F 17/30333; G06F 17/30601; G06F 17/30873

(57) ABSTRACT

A system for use on a global computer network, such as the Internet, allows for the creation, development, maintenance and sharing of information in a particular formulated and structured method. Accredited members (users) are represented by a six-sided three dimensional graphical cube (block). A primary cluster of cubes provides for clustering of data relating to people, products, places and services (i.e., P³S), while secondary cube clusters are used to classify animals and plants, for example. The six sides of each cube correspond to the six generic questions about who, what, where, when, why and how (i.e., W⁵H) concerning P³S. The data information of each represented cube is stored on a page or book of pages that are arranged on the six sides of the cube to supply interaction and answers to W⁵H relating to P³S clusters. Members communicate and interact to access P³S clusters and obtain content about W⁵H.

### BACKGROUND OF THE INVENTION

Field of the Invention

The invention relates to a system, method and device for use on a global computer network and, more particularly, to a system and method that incorporates one or more databases, a network and user devices that allows for the creation, development, maintenance and sharing of information in a particular structure and format that focuses on presenting a unique structure of integrating and linking people, places, products and services on a global computer network.

Discussion of the Related Art

As of the year 2015, the World Wide Web has created awareness to over 3.2 billion users on how content is managed and information is shared on a global computer network. Technology has made our world more accessible by bringing a wider choice of products and services to our attention, in an instant, forcing upon us the perception that we can rely on the World Wide Web to supply suitable answers to any question or solutions to any problem. However, the value, worth, accuracy, trustworthiness, or the identity about people, products, places or services is never certain or 100 percent reliable since the World Wide Web allows everyone with access to software and hardware to create and share content. As a result, people continue to spend a great deal of time, and often unnecessary time, navigating their way through pages and pages of repetitive information on the World Wide Web in search of illusive answers. The Internet has established a means for electronic transfer of funds and secure financial transactions to be processed from users all over the world. However, fraud still exists with insufficient security or at a high cost for effective security measures that need to be implemented and updated regularly. Moreover, a search result will not always be entirely accurate, resulting in wasted productivity, because of the freedom of website developers to use matching key phrases and words. As a quality and productive conscience society, we care for measurable, reliable and accurate outcomes. Accordingly, there remains a definite need for a computer system that operates in a secure environment in which communications, transactions and information can be shared on a global computer network among accredited users.

### OBJECTS AND ADVANTAGES OF THE INVENTION

Considering the foregoing, it is a primary object of the present invention to provide a system and method that includes a uniquely structured database(s), a network and user devices, and wherein the invention simplifies people's daily activities to ensure that more time is spent on life itself.

It is a further object of the present invention to provide a system, method and device for use on a global computer network, such as the Internet, which allows for the creation, development, maintenance and sharing of information in a particular format and structure.

It is still a further object of the present invention to provide a system, method and device for use on a global computer network that solves the challenge of verification and authentication about people, places, products and services and which eliminates the unnecessary time spend on searching for solutions on a global computer network, such as the Internet.

It is a further object of the present invention to provide a system and method, including a specifically structured database for integrating and linking people, places, products and services over a global computer network, such as the Internet.

It is still a further object of the present invention to provide a system and method for building a virtual community of cubes in a database, with the unique feature of allowing virtual cubes to represent people, places, products and services and with the additional feature of information loaded on the cubes concerning who, what, why, where, when and how with respect to people, places, products and services.

These and other objects and advantages of the present invention are more readily apparent with reference to the following detailed description taken in conjunction with the accompanying drawings.

### SUMMARY OF THE INVENTION

The invention is about engineering a socio-economic order and society on a global computer network, wherein representation of accredited members and their respective collated, authenticated and verified data is arranged in a cube format and stored in a secured database or cube community using a user friendly device to interact, communicate and share information. The focus of the invention is more in the methodology of how information concerning or relating to “who, what, where, when, why and how (i.e., W⁵H)” about “people, products, places and services (i.e., P³S)” is structured, presented and formulated, and hence the following equation: W⁵H(P³S)=AD^{it} (wherein AD^{it} represents the system and method of the present invention).

The key condition is that a cube (block) represents an accredited person, registered product, specific property or a qualified service verified and authenticated as a member (user) of the cube community. The system may include a device with software properties that simulate a three dimensional space in which cubes (blocks) float and can assume a standard arrangement of twenty seven cubes (blocks), consisting of three layers of nine cubes (blocks). The cubes (blocks) can be modified, customized and personalized by the end user in an animated control operating environment to allow for customization and arrangement of the cubes (blocks) in order of preference relating to other members, as well as in relation to other people, products, places or services.

### BRIEF DESCRIPTION OF THE DRAWINGS

For a fuller understanding of the nature of the present invention reference should be made to the accompanying drawings in which:

FIG. 1 is a perspective diagram illustrating the six-sided surface properties of a cube according to the system and method of the present invention;

FIG. 2 is a perspective diagram illustrating the six-sided surface properties of a cube associated with people and personalities according to the system and method of the present invention;

FIG. 3 is a perspective diagram illustrating the six-sided surface properties of a cube associated with products in accordance with the system and method of the present invention;

FIG. 4 is a perspective diagram illustrating the six-sided surface properties of a cube associated with places in accordance with the system and method of the present invention;

FIG. 5 is a perspective diagram illustrating the six-sided surface properties of a cube associated with services in accordance with the system and method of the present invention;

FIG. 6 is a perspective diagram of a standard arrangement of cubes to be displayed on a handheld device, 27 cubes provide access to 162 pages of information about the who, what, where, when, why and how concerning a particular person, product, place or service;

FIG. 7 is a perspective diagram illustrating a customized arrangement of 216 cubes, thereby providing access to 1,296 information pages;

FIG. 8 is a top perspective view illustrating a handheld electronic device of the present invention; and

FIG. 9 is a schematic diagram of the system and method of the present invention.

### DETAILED DESCRIPTION OF THE PREFERRED EMBODIMENT

The present invention is directed to a system, method and device for use on a global computer network, such as the Internet, that allows for the creation, development, maintenance and sharing of information in a particular formulated and structured method among accredited members (i.e., users). The unique structure of the database of the present invention allows for building a virtual community of cubes representing people, places, products and services. The cubes in the database are specifically structured for arranging and storing data concerning “who, what, why, where, when and how” relating to “people, places, products and services.” The six sides of each cube in the database allows for six different areas (who, what, why, where, when and how) to be uniquely stored and arranged for access in a search for a place, service, product or another person. The system allows for individuals, organizations and companies to own a cube (i.e., virtual estate property in cyberspace) and to register their products, services and/or places (e.g., property owners) to their cube. The structural arrangement of cubes in a database accessible over a global computer network allows people to be linked with other people, in touch with products, associated with places and connecting to services. The practical application of the system of the present invention is endless and provides opportunities for ecommerce, stock trades, voting and consensus recording, among a host of other possibilities.

According to the system of the present invention, every individual, place, product and service provider has its own cube (block) classified under one of the following: a person; a place; a product; or a service.

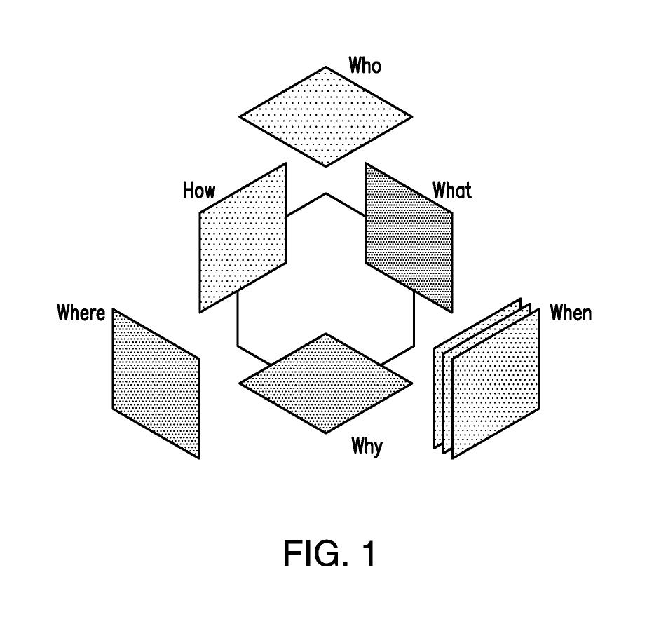

The six-sided surface properties of a cube (block) represent the 6 generic questions about who, what, where, when, why and how concerning people, products, places and services respectively. Each cube (block) side is a ‘page’ or ‘book of pages’ about who, what, where, when, why and how concerning people, products, places and services respectively. See FIG. 1.

The Cube Community

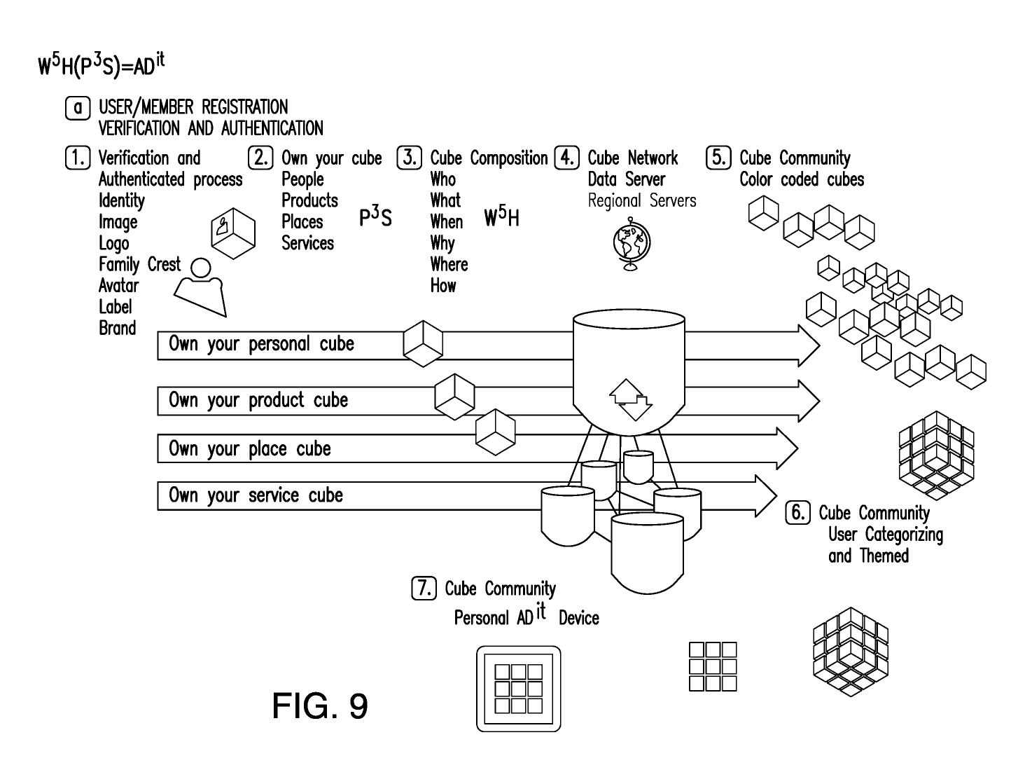

The invention is based on the classification of authenticated members to be clustered into 4 key areas or “categories”, namely people, products, places and services, as seen in FIG. 9. Anyone can be a member as long as they are registered, verified, authenticated and accredited. As this cube community represents the bona fide world of mankind and other life forms, interaction among members such as communications, sharing files, transactions and trade is reliable and secured. The system and method also provides secondary cube clusters to classify animals, plants and other life forms that will also be ‘members’ of the cube community.

People or Personalities (P)

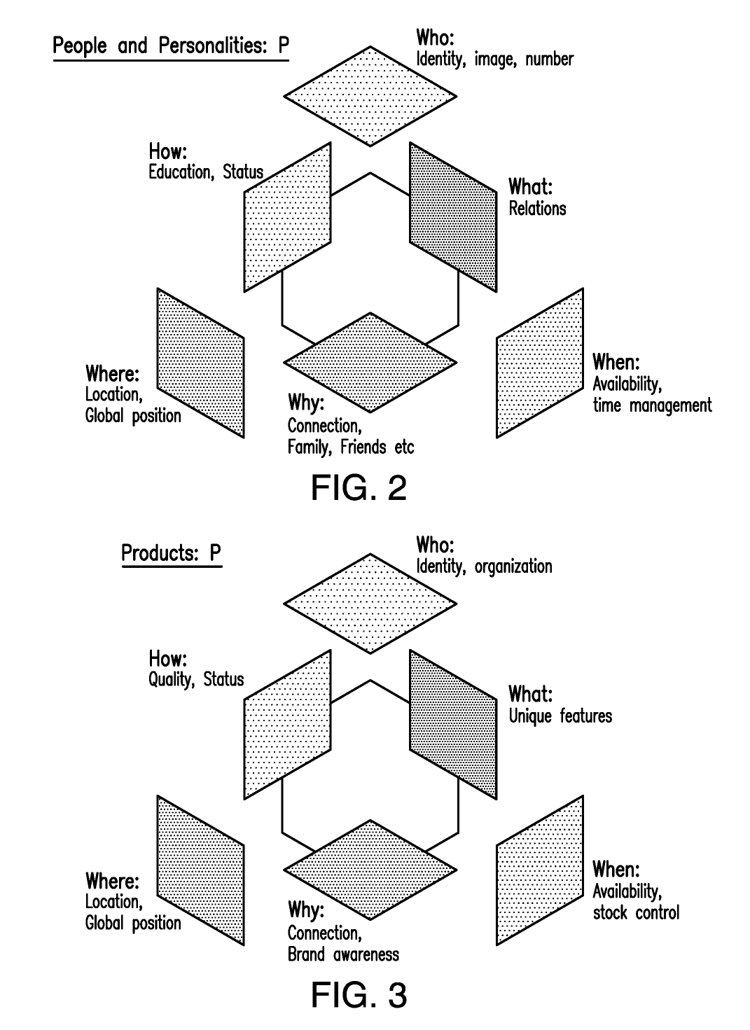

The description of this category of color coded cube clusters covers people, animals, insects and other living organisms. Referring to FIG. 2, a single cube (block) represents a person, animal, insects and other life forms with who, what, where, when, why and how about each respectively.

The ‘who’ describes everything in association with identity information to a secure and acceptable authenticated standard. The ‘what’ describes everything associated to relation information according to a secure and acceptable familiarity experience. The ‘where’ describes everything associated to location information on a secure and acceptable global positioning standard. The ‘when’ describes everything associated to availability information according to a secure and acceptable time and status management standard. The ‘why’ describes everything associated to connection information according to a secure and acceptable family, friend or colleague standard. The ‘how’ describes everything associated to education and occupation information according to a secure and acceptable qualification standard.

Products (P)

The description of this category of color coded cube clusters covers all products from natural resources, raw material to man manufactured objects. As shown in FIG. 3, a single cube (block) represents a product with who, what, where, when, why and how about the product.

The ‘who’ describes everything in association with information on the organization according to a secure and acceptable authenticated standard. The ‘what’ describes everything on information about unique features according to a secure and acceptable product. The ‘where’ describes everything associated to location information on a secure and acceptable global positioning standard. The ‘when’ describes everything associated to availability information according to a secure and acceptable time and status management standard. The ‘why’ describes everything associated to connection information according to a secure and acceptable brand awareness standard. The ‘how’ describes everything associated to instruction and quality information according to a secure and acceptable condition standard.

Places (P)

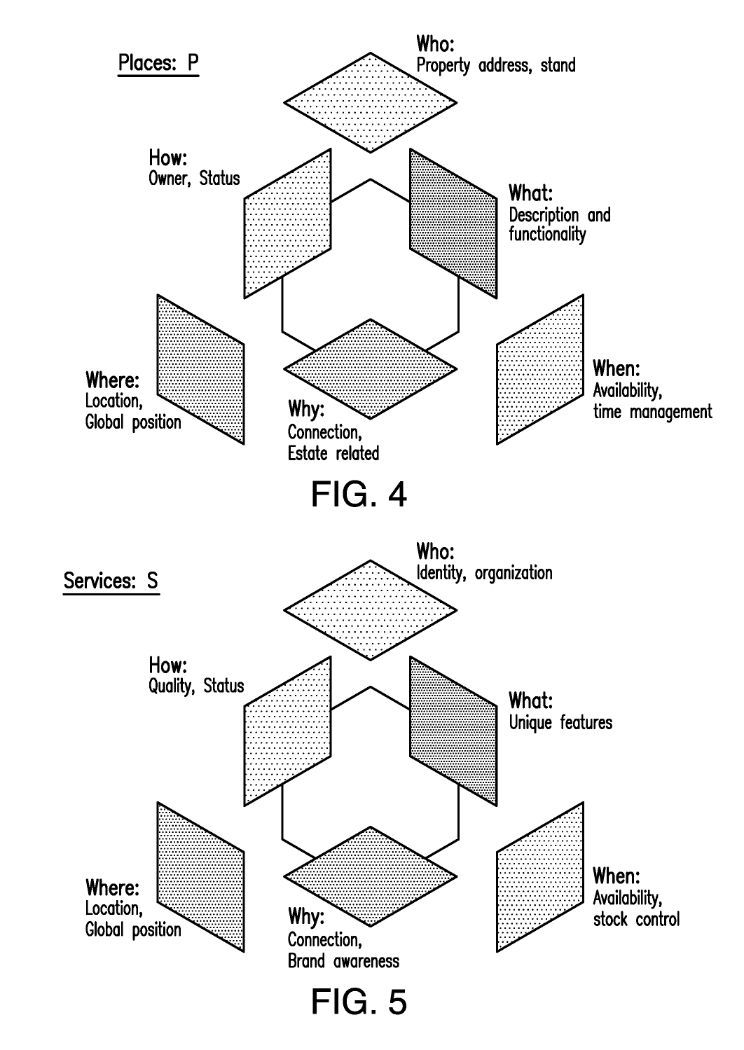

The description of this category of color coded cube clusters covers remote locations, from galaxies to remote regions, from countries to cities, from forests to urbanized regions, from towns to suburbs, from owned homes to rented apartments. Referring to FIG. 4, a single cube (block) will represent a place with who, what, where, when, why and how about the place.

The ‘who’ describes everything in association with information on the organization according to a secure and acceptable authenticated standard. The ‘what’ describes everything on information about unique features and function according to a secure and acceptable property. The ‘where’ describes everything associated to location information on a secure and acceptable global positioning standard. The ‘when’ describes everything associated to availability information according to a secure and acceptable time management standard. The ‘why’ describes everything associated to information according to a secure and acceptable estate awareness standard. The ‘how’ describes everything associated to instruction and owner information according to a secure and acceptable legal standard.

Services (S)

The description of this category of color coded cube clusters covers all human being related activities serving other people, from governmental to laundry services. As shown in FIG. 5, a single cube (block) represents a service with who, what, where, when, why and how about the service.

The ‘who’ describes everything in association with information on the organisation according to a secure and acceptable legitimate standard. The ‘what’ describes everything on information about unique features according to a secure and acceptable quality. The ‘where’ describes everything associated to location information on a secure and acceptable global positioning standard. The ‘when’ describes everything associated to availability information according to a secure and acceptable time and status management standard. The ‘why’ describes everything associated to connection information according to a secure and acceptable brand awareness standard. The ‘how’ describes everything associated to instruction and livelihood information according to a secure and acceptable condition standard. See diagram 3.4.

Color Coded Cubes

The method of using color coded cubes (blocks) is to employ identification in order to classify categories of interest, such as red for medical and health, blue for entertainment, travel and leisure, yellow for property and residence, green for nature and conservation, orange for education and training, purple for social welfare, brown for agricultural, grey for industrial and manufacturing, etc.

The Device as a Portal to the System

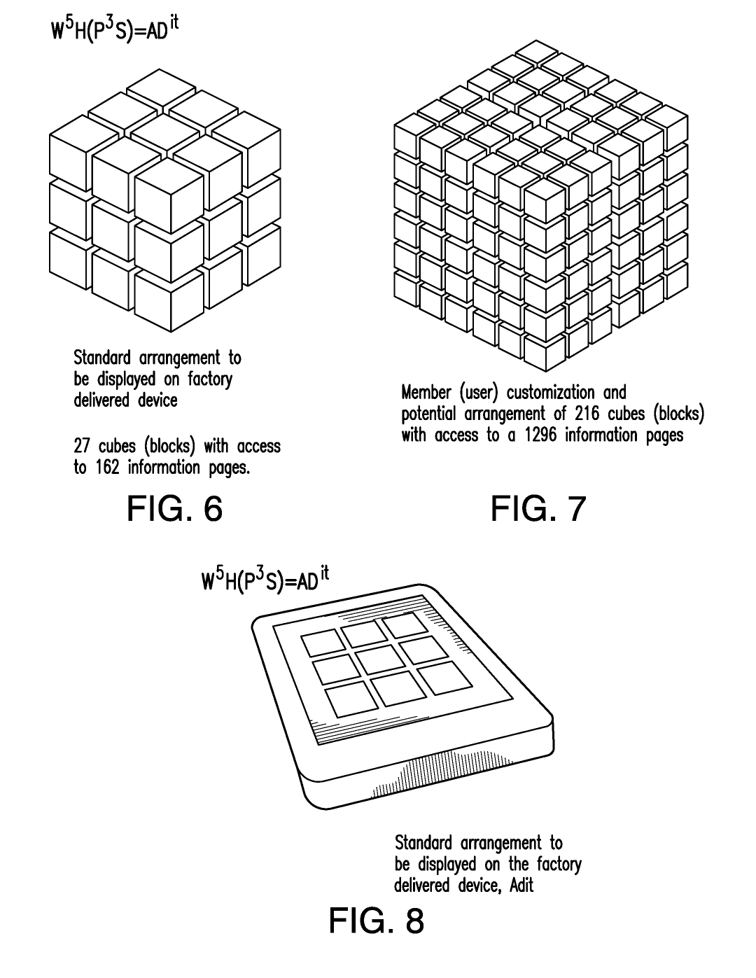

The system of the present invention may incorporate a user friendly hand held device, as shown in FIG. 8. On start up, the device introduces users to a first standard level of nine color coded cubes (blocks) with a second and third level each with 9 cubes (blocks) respectively on x, y and z rotation, therefore a total of 27 cubes (blocks), as seen in FIG. 6. It is capable with an operating system to support a simulated three dimensional environment with animated features assisting the end user to manipulate the introduction standard of nine color coded cubes (blocks) that are directly accessible on the first level. Together with the second level of nine color coded cubes (blocks) and the third level of nine color coded cubes (blocks) calculates to 27 different accessible cubes (blocks) on the subject of people, products, places and services in user customisable preferential order on who, what, where, when, why and how respectively, thereby providing a total of 162 sides/squares of information. This arrangement can be modified to accommodate more cubes (blocks) as per member (user) requirement. See FIG. 7.

While the present invention has been shown and described in accordance with a preferred and practical embodiment, it is recognized that departures from the instant disclosure are fully contemplated within the spirit and scope of the present invention which is not limited except as defined in the following claims as interpreted under the Doctrine of Equivalents.

What is claimed is:

1. A database system for a virtual online community that is accessible on a global computer network, comprising:
a plurality of cubes, each of said plurality of cubes including six sides and each of said six sides having at least one page for arranging, storing, accessing and sharing data corresponding to one of six question categories of who, what, where, when, why and how, in each of said six question categories concerning the subject categories of people, products, places and services, and wherein each side of said cube and the data arranged and stored thereon relates to a corresponding one of the six question categories.

2. The database structure as recited in claim 1 further comprising:
a plurality of cube clusters, each of said plurality of cube clusters comprising at least two cubes, and each of said plurality of cube clusters corresponding to one of the four subject categories of people, products, places and services.

3. The database structure as recited in claim 2 wherein each of said plurality of cubes is associated with one of the four subject categories of people, products, places and services.

4. The database structure as recited in claim 3 wherein each of said plurality of cubes is assigned to an individual person, a business entity or an organization that is registered with the system.

5. The database structure as recited in claim 4 wherein a portion of said plurality of cubes are individually assigned to animals, plants and other life forms.

6. The database structure as recited in claim 5 wherein said plurality of cubes are each color coded to correspond with a particular area or field within each of the four subject categories of people, products, places and services, thereby allowing for visual identification of the subject category and area or field of each of said plurality of cubes when visually displayed.
